(19) United States
(12) Patent Application Publication
(10) Pub. No.: US 2024/0313192 A1
(43) Pub. Date: Sep. 19, 2024

(54) METHOD FOR OPERATING A ROLLING DEVICE FOR MANUFACTURING AN ELECTRODE SHEET, AND ROLLING DEVICE

(71) Applicant: Volkswagen Aktiengesellschaft, Wolfsburg (DE)

(72) Inventors: Sven SCHOPF, Braunschweig (DE); Ludger BUSSWINKEL, Braunschweig (DE); Sebastian REUBER, Dresden (DE)

(73) Assignee: Volkswagen Aktiengesellschaft, Wolfsburg (DE)

(21) Appl. No.: 18/605,545

(22) Filed: Mar. 14, 2024

(30) Foreign Application Priority Data
Mar. 14, 2023 (DE) 10 2023 202 305.9

(51) Int. Cl. H01M 4/04

(52) U.S. Cl. CPC H01M 4/0435

(57) ABSTRACT

A method and device for operating a rolling device for manufacturing an electrode sheet. The rolling device including a rolling mill for forming a material film for the electrode sheet, which includes a roller pair and includes an application roller which is separate from the roller pair or is a part of the roller pair. The application roller being supplied with a substrate for the electrode sheet, the rolling mill having a film forming gap, which is formed by the roller pair, which outputs a quantity of material and which produces the material film therefrom. The material film being applied to the application roller and being transferred from the application roller to the substrate. The material film having a grammage and a film thickness, the grammage and/or the film thickness being regulated to a setpoint value, and the rolling device being controlled depending on the grammage and/or the film thickness.

This nonprovisional application claims priority under 35 U.S.C. § 119(a) to German Patent Application No. 10 2023 202 305.9, which was filed in Germany on Mar. 14, 2023, and which is herein incorporated by reference.

### BACKGROUND OF THE INVENTION

### Field of the Invention

The invention relates to a method for operating a rolling device for manufacturing an electrode sheet as well as a corresponding rolling device. In particular, the invention thus also relates to the manufacturing of an electrode sheet as well as a corresponding electrode sheet.

### Description of the Background Art

An electrode sheet is regularly used to manufacture a battery. The battery is then used, for example, to supply power to an electric drive of a vehicle, such as a passenger car or a truck. The electrode sheet is typically manufactured as a continuous sheet, which is then prefabricated to individual electrodes. One or multiple electrodes are subsequently stacked or rolled and combined into a cell. One or multiple cells of this type are then suitably connected to each other and placed in a housing to form a battery.

When manufacturing an electrode sheet, a substrate is first provided, usually a foil made from a conductive material, such as copper or aluminum. A material film is then applied to the substrata, which is made up, among other things, of an active material and contains, for example, lithium or a lithium compound, for manufacturing a lithium battery. The manufacturing of the electrode may take place, in principle, dry or wet, depending on the configuration of the active material for the material film.

A method for manufacturing a dry film is known from WO 2018/210723 A1, which corresponds to US 2021/0320288. A dry powder mixture is processed into the dry film with the aid of a rolling device, which includes a first roller and a second roller. The first roller has a higher rotational circumferential speed than the second roller, and the resulting dry film is supported on the first roller.

It is described in US 2022/0006071 A1 that the thickness of the freestanding film and the degree of compression of this film is controlled by repeated calendering during the dry electrode manufacturing. In contrast to the wet electrode manufacturing, the extent of control over the grammage and the film thickness is limited thereby.

Reference is also made to US 2020/0144591 A1.

### SUMMARY OF THE INVENTION

It is therefore an object of the invention to improve the manufacturing of an electrode sheet, in particular the dry manufacturing. For this purpose, an improved method for operating a rolling device as well as a corresponding rolling device are to be specified.

The examples in connection with the method also similarly apply to the rolling device and vice versa. To the extent that steps of the method are implicitly or explicitly mentioned below, advantageous examples for the rolling device result, in particular, in that it has at least one control unit, which is designed to carry out one or multiple of these steps.

The method is used to operate a rolling device. A preferred rolling device is described in WO 2018/210723 A1, which corresponds to US 2021/0320288, which is incorporated herein by reference, and as mentioned at the outset, a rolling device of this type also being assumed below without any loss of generality. The rolling device is also referred to as a calender. The rolling device is used for the manufacturing of an electrode sheet. The electrode sheet is used, in particular, to manufacture a battery, which is then preferably used to supply power to an electric drive of a vehicle, such as a passenger car or truck. The electrode sheet is first manufactured, in particular, as a continuous sheet using the rolling device and then possibly prefabricated as needed.

During the manufacturing of the electrode sheet, a substrate and at least one material film are assembled. The combination of substrate and material film then forms the electrode sheet. For the purpose of forming the material film for the electrode sheet, the rolling device includes a rolling mill having a roller pair and an application roller. The application roller is either designed to be separate from the roller pair or is a part of the roller pair, i.e., one of two rollers of the roller pair. In any case, the rolling mill includes at least two rollers for producing the material film, the rolling device also correspondingly being referred to as a multi-roller system or multi-roller calender. The rolling device may include multiple rolling mills to coat the substrate with a material film on each of both sides.

The rolling mill has a film forming gap, which is formed by the roller pair, i.e., the film forming gap is formed between the two rollers of the roller pair and thus has a gap width which corresponds to the distance of the rollers from each other. The film forming gap outputs a quantity of material (i.e., a quantity per time unit) and produces the material film therefrom. The material film is thus primary-formed with the aid of the film forming gap. The gap width of the film forming gap greatly influences the production of the material film. The material for this purpose is supplied in particular, with the aid of a metering apparatus of the rolling device, namely to a gusset which is formed between the two rollers of the roller pair and which opens into the film forming gap. In addition to the gap width, in particular, a relative speed of the two rollers in relation to each other (similarly to a corresponding shear rate) also determines the production of the material.

The material is present, in particular, in the form of a powder. The material is, in particular, a battery powder mixture. The material contains, in particular, at least one active material. The active material contains, for example, lithium or a lithium compound. The material furthermore preferably includes a binder and/or a conducting additive. The material is preferably free of liquid constituents or contains at least no more than 3 wt. % of liquid constituents, particularly preferably no more than 1 wt. %. A material of this type can also be referred to as “dry material,” and a method in which a material of this type is used is referred to as a “dry method for manufacturing an electrode sheet” or equivalently as “dry electrode manufacturing.” Liquid constituents are, in particular, solvents and/or lubricants, so that the material is preferably free of solvents and/or lubricants, or solvents and/or lubricants are contained in no more than small amounts as described.

The two rollers of the roller pair are operated, in particular, at different circumferential speeds to produce the material film. As a result, a shearing force arises at the film forming gap, which acts upon the material and influences the production of the material film accordingly. The shearing force is dependent on a difference of the two circumferential speeds, i.e., a relative speed of the one roller of the roller pair with respect to the other roller of the roller pair. The one of the two rollers which has the lower circumferential speed is also referred to as the shearing roller. The other of the two rollers is then either the application roller or is referred to as a transfer roller. The material film is produced, in particular, on the roller which has the higher circumferential speed, i.e., on the application roller or the transfer roller, depending on the design.

Within the scope of the method, the material film is applied to the application roller. If the application roller is a part of the roller pair, the material film is preferably applied directly to the application roller starting from the film forming gap. However, if the application roller is designed to be separate from the roller pair, the material film is preferably applied directly to the transfer roller starting from the film forming gap. The material film is then transferred from the film forming gap to the application roller via the transfer roller. The transfer roller transfers the material film to the application roller either indirectly or directly.

The substrate is, in particular, a foil made from a conductive material, e.g., copper or aluminum. The substrate for the electrode sheet is now supplied to the application roller, and the material film is transferred to the substrate from the application roller, i.e., the substrate is coated with the material film. The substrate is advantageously coated with an adhesion-promoting agent or the like to securely fix the material film on the substrate. The transfer of the material film to the substrate is also referred to as “lamination.”

The material film is, in particular, not self-supporting but is supported continuously by one or multiple rollers from the film forming gap to the substrate. The material film is therefore also referred to as a “roller-supported material film.”

To transfer the material film to the substrate, the rolling device suitably includes a counter-roller to the application roller. The counter-roller is either a separate roller or an application roller of a second rolling mill, similarly to the (first) rolling mill already described. A gap is then formed between the counter-roller and the application roller, through which the substrate is passed and in which the material film is transferred to the substrate. During the transfer to the substrate, the material film is preferably not compressed or only slightly compressed, i.e., compressed by no more than 5%. In this case, the gap is also referred to as a “laminating gap.” This case is assumed below without any loss of generality.

If no transfer roller is present, the material film in the laminating gap is preferably compressed to a target density, so that a further calendering is not necessary and also does not take place. However, if a compression to the target density is not possible in the laminating gap, e.g., if a transfer roller is used, the material film is advantageously recompressed, in particular to the target density, downstream from the laminating gap with the aid of a calender.

The material film generally has a grammage and a film thickness. The film thickness is measured, in particular perpendicularly to a width and a length of the material film (and thus also perpendicularly to the surface of the rollers as well as perpendicularly to the substrate) and its smallest extension. The film thickness is typically in the range from 30 μm to 200 μm, preferably in the range from 40 μm to 150 μm. The grammage indicates the mass per unit area of the material film, the unit area extending in the direction of the length and the width of the material film. The grammage is typically in the range from 50 g/m2 to 300 g/m2. The grammage is also referred to as loading or coverage. If the grammage of the material film is constant, the film thickness is equivalent to a film thickness of a material film, i.e., the mass of material film per volume unit.

In contrast to the film thickness, the grammage may no longer be set after the transfer of the material film to the substrate, since no more material may be added or removed. The film thickness is still settable only by means of additional calendering, but only in the direction of lower values. However, the grammage remains the same during calendering. The grammage and also the film thickness are, however, settable prior to transferring the material to the substrate by means of a corresponding control of the rolling device. In the present case, the grammage and/or the film thickness are regulated to a setpoint value (in particular a setpoint value from the ranges mentioned above), and the rolling device is controlled for this purpose depending on the grammage and/or the film thickness. This is understood to mean that either the grammage or the film thickness is regulated to a setpoint value or that both take place simultaneously, i.e., the grammage and the film thickness are regulated to a particular setpoint value. The setpoint value is also referred to as target loading for the grammage and correspondingly as target thickness for the film thickness. An essential advantage of the invention is correspondingly that the manufacturing of the electrode sheet is particularly precise, and specifications relating to the grammage and/or the film thickness are particularly easily and precisely implemented. A design, in which at least the grammage is regulated, is particularly preferred, since it may no longer be changed after the material film is transferred to the substrate, as described.

In the case of the dry electrode manufacturing, it is generally possible to achieve a predefined grammage (“target loading”) and a predefined film thickness (“target thickness”) in that the rolling device is operated using different operating parameters, so that an electrode sheet is manufactured, along which the grammage and film thickness vary. Only the regions of the electrode sheet which have the predefined grammage and the predefined film thickness are then further processed, all other regions being discarded. However, this inevitably results in rejects and is correspondingly inefficient and cost-intensive. An automatic setting and adaptation (namely a regulation) of the rolling device is implemented by the present invention, whereby it is ensured that the predefined grammage and/or the predefined film thickness are generated continuously or at least predominantly. Correspondingly fewer rejects arise thereby during the manufacturing of the electrode sheet.

In the case of the present invention, the electrode sheet is not processed only later on, i.e., after the material film is transferred to the substrate, to set the grammage and film thickness, but the material film is instead correspondingly suitably produced prior to the transfer to the substrate. In particular, this makes it possible to set the grammage in the first place. With regard to setting the film thickness, at least the advantage results that a subsequent calendering of the electrode sheet is omitted, and the rolling device is correspondingly simplified.

To regulate the grammage and/or the film thickness to a particular setpoint value, the rolling device includes, in particular, a control unit as well as at least one measuring unit and at least one controller, which are connected to the control unit or are a part thereof. A control variable is measured with the aid of the measuring unit, and an actual value is determined therefrom, which is then forwarded to the controller. The controller is also supplied with the setpoint value. Depending on a deviation of the actual value from the setpoint value (control deviation), the controller then controls the rolling device, i.e., a corresponding manipulated variable. Different suitable embodiments thereof are described below. These embodiments differ from each other, in particular, in the selection of the control variable and its measurement as well as in the manipulated variable, i.e., in how the rolling device is specifically controlled. The different embodiments or only individual aspects thereof may generally be combined with each other.

The already mentioned gap width of the film formation gap and the relative speed of the rollers of the roller pair are particularly suitable as the manipulated variable. Correspondingly, in a suitable embodiment, the rolling device is controlled in that the gap width of the film forming gap is set. Alternatively or additionally, the roller pair includes two rollers, as described above, which are operated at different circumferential speeds to produce the material film, and the rolling device is then controlled in that a difference of the circumferential speeds is set. Due to the two measures, the quantity of material which is output from the film forming gap (per time unit), is set directly in each case, and thus also the grammage and film thickness of the material film. If both the gap width and the relative speed are correspondingly controlled, the grammage and film thickness may advantageously also be set independently of each other. By controlling the gap width of the film forming gap, the grammage is advantageously set, and the film thickness, and thus the density of the material film, is set by a control of the gap width of the laminating gap or the gap width between the transfer roller and application roller. If a measurement of the grammage on one of the rollers is not possible, the film thickness is suitably used to equalize the two sides of the electrode sheet and, in particular, to monitor the process. Nevertheless, the grammage, in particular from the measurement on the substrate, is advantageously set as the target variable, i.e., in particular set to a setpoint value.

The grammage or the film thickness or both are preferably measured and used directly as the actual value. A corresponding target loading or target thickness is then used as the setpoint value. However, an embodiment is also possible and suitable, in which the actual value (and similarly the setpoint value) is only derived from the grammage or the film thickness or from both together and is correspondingly abstracted if possible, e.g., not indicated in units of grammage or of film thickness. In one advantageous embodiment, the grammage is derived from a measurement of the film thickness. For this purpose, the film thickness is measured, in particular, on the application roller (or similarly on the transfer roller) and then, in combination with the circumferential speed (equivalent: rotational speed and roller diameter) of the application roller and the quantity of material output from the film forming gap, an actual value for the grammage is calculated, and a regulation of the grammage is thus carried out, based on a measurement of the film thickness. Alternatively or additionally, the grammage is measured downstream from the laminating gap, and the film thickness is preferably used to monitor a uniformity of the two sides of the electrode sheet, i.e., in particular, whether the film thickness on the two sides is the same.

A measurement of the grammage and the film thickness is possible and advantageous at different points on the rolling device. In one suitable embodiment, the grammage and/or the film thickness are measured on the material film while the material film is being applied to the application roller, i.e., it is measured on the application roller. Alternatively or additionally, the grammage and/or the film thickness is/are measured on the material film while the material film is being applied to the substrate, i.e., they are measured downstream from the application roller and on the substrate. The measurement of the grammage takes place, for example, with the aid of an absorption measurement, in which the absorption of, for example, x-rays or ultrasound is measured in the material film, e.g., in transmission. This is particularly easily possible on the material film on the substrate, since it is regularly free-standing downstream from the application roller. In principle, however, a measurement of the grammage on the roller-supported material film prior to the transfer to the substrate is also conceivable. The film thickness is measured, for example, visually in reflection and in comparison to a reference. A combination is particularly preferred, in which the film thickness is measured while the material film is being applied to the application roller, and the grammage is measured while the material film is being applied to the substrate. These two measurements are particularly easy. In one embodiment, in which a material film is applied to each side of the substrate, the measurement of the grammage supplies only one value (actual value) for both material films together. With the aid of the additional measurement of the film thickness of the individual material films prior to the transfer to the substrate, this value is then divided to the two material films according to the ratio of the two film thicknesses, and the particular grammage is thus determined at least approximately correctly for each of the material films.

Similarly to the gap width of the film forming gap and the relative speed of the rollers of the roller pair, in a rolling device including a transfer roller, the use of the gap width of the gap between the transfer roller and the application roller as the manipulated variable, on the one hand, and/or the use of the relative speed between the transfer and the application roller as the manipulated variable, on the other hand, is/are alternatively or additionally advantageous. As already described, in one advantageous embodiment, the rolling device includes a transfer roller, which is arranged upstream from the application roller and via which the material film is transferred from the film forming gap to the application roller. The term “upstream” (similarly “downstream”) is understood with regard to a transport direction of the material film. The rolling device is then controlled in that a gap width of the gap between the transfer roller and the application roller is set, and/or in that the difference of the circumferential speeds (i.e., the relative speed) of the transfer roller and the application roller is set.

Similarly to the measurement of the grammage and/or the film thickness on the application roller, and alternatively or additionally hereto in one suitable embodiment, the grammage and/or the film thickness is/are likewise measured while the material film is being applied to the transfer roller, i.e., it is measured on the transfer roller.

Different configurations for the rolling device may be considered, all of which are suitable for the method described here. The optional use of a transfer roller has already been described. A coating on one or both sides of the substrate is also possible, the latter being preferred. Correspondingly, in one suitable embodiment, the substrate is coated on both sides with the aid of the rolling device, i.e., a material film is applied as described on each of the two sides of the substrate. The already described (first) material film is then applied to a first side of the substrate, and the rolling device includes a further (second) rolling mill, with the aid of which a further (second) material film is produced, which is applied to an opposite, second side of the substrate. The second material film also has a grammage and a film thickness. The production of the two material films and their transfer to the substrate preferably proceed in the same way, i.e., the rolling device has a rolling mill for each of the material films. The measurements and regulating processes described are advantageously carried out equally according to the above and following descriptions for both rolling mills and material films. The rolling mills are either offset with respect to a transport direction of the substrate, so that the two material films are transferred to the substrate one after the other, or are arranged at the same position, so that the two material films are transferred to the substrate at the same time. In the latter case, the two application rollers are then each also simultaneously a counter-roller for the other application roller. The case in which the two material films are applied one after the other is advantageous insofar that a measurement of the grammage and/or the film thickness is possible on a single material film while the latter has already been applied to the substrate. In one advantageous embodiment, the grammage and/or the film thickness is/are correspondingly measured on the material film while the latter is being applied to the substrate, but still before the second material film is applied to the opposite side of the substrate. The grammage and/or the film thickness is/are correspondingly measured downstream from the application roller of the first rolling mill and upstream from the application roller of the second rolling mill.

In the case of a substrate coated on both sides, the two rolling mills are preferably controlled in such a way that a difference of the two film thicknesses is minimized, i.e., the material films are automatically formed to be of the same thickness. This is particularly advantageous in combination with a measurement of the grammage of the substrate coated on both sides, as has already been described above.

In an example, a fill level of the material upstream from the film forming gap is optionally regulated to a fill level setpoint value depending on a fill level actual value or depending on the grammage and/or the film thickness, i.e., a fill level adjustment takes place. This ensures that the gusset of the roller pair does not empty or overflow. The fill level regulation takes place either in a decentralized manner, and thus independently of the regulation of the grammage and/or the film thickness, in particular in that the fill level actual value is simply measured, and the supply of material to the gusset is controlled depending thereon. Alternatively, the fill level regulation takes place centrally, in particular in that the supply is controlled depending on the grammage and/or the film thickness.

An embodiment is also advantageous, in which the laminating gap is additionally controlled, in particular depending on the grammage and/or the film thickness. The gap width of the laminating gap is suitably regulated depending on the film thickness, in particular the film thickness of the material film on the substrate.

The rolling device according to the invention includes a control unit, which is designed and, in particular also configured, to carry out a method as described above. The control unit takes over, in particular, one or multiple of the control and regulating tasks described above. All control and regulating tasks are either implemented centrally in a single control unit or distributed in a decentralized manner to multiple corresponding control units, for example, a particular regulation is implemented for the film thickness and the grammage independently of each other using separate control units.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

Exemplary embodiments of the invention are explained in greater detail below on the basis of a drawing. In each case,

FIG. 1 schematically shows a vehicle;

FIG. 2 schematically shows a rolling device;

FIG. 3 schematically shows a variant of the rolling device;

FIG. 4 schematically shows a further variant of the rolling device;

FIG. 5 schematically shows a further variant of the rolling device; and

FIG. 6 shows a fill level regulation for a rolling device.

### DETAILED DESCRIPTION

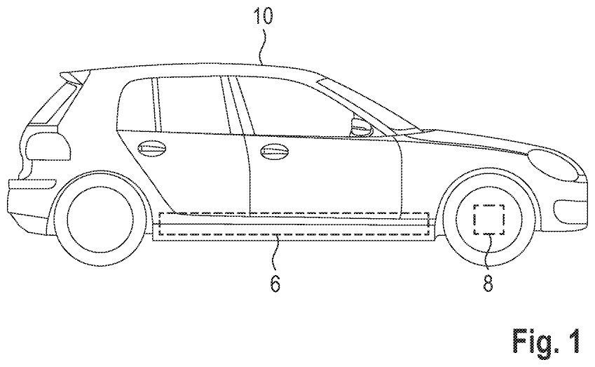

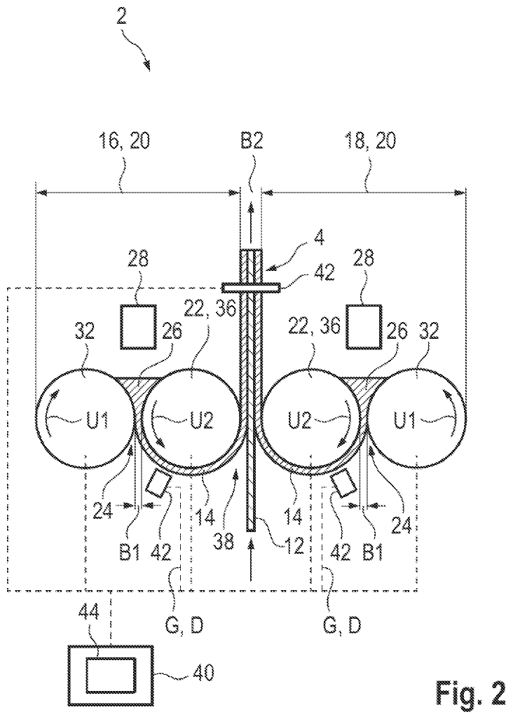

The method according to the invention is used to operate a rolling device 2. An exemplary embodiment of rolling device 2 is illustrated in each of FIGS. 2 through 5, the method also being explained below on the basis of these exemplary embodiments. Rolling device 2 is used to manufacture an electrode sheet 4. Electrode sheet 4 is used, for example, to manufacture a battery 6, which is then used to supply power to an electric drive 8 of a vehicle 10, such as a passenger car, as illustrated in FIG. 1. In the present case, electrode sheet 4 is first manufactured as a continuous sheet using rolling device 2 and then possibly prefabricated as needed (not illustrated).

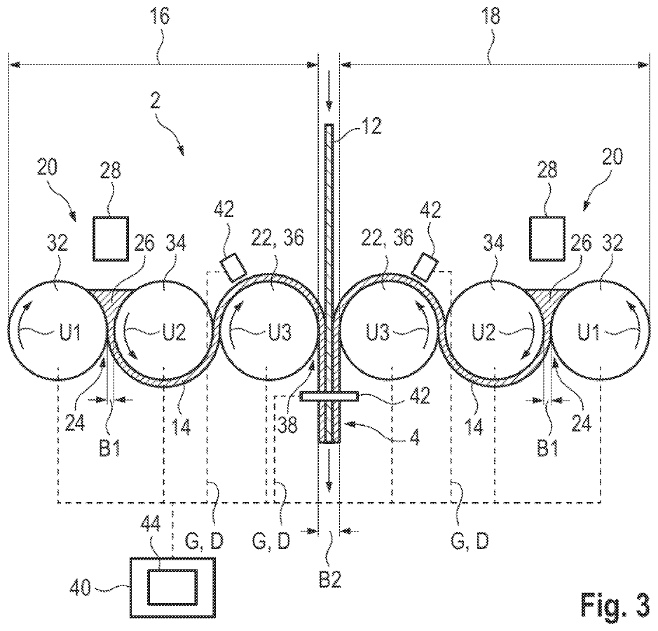

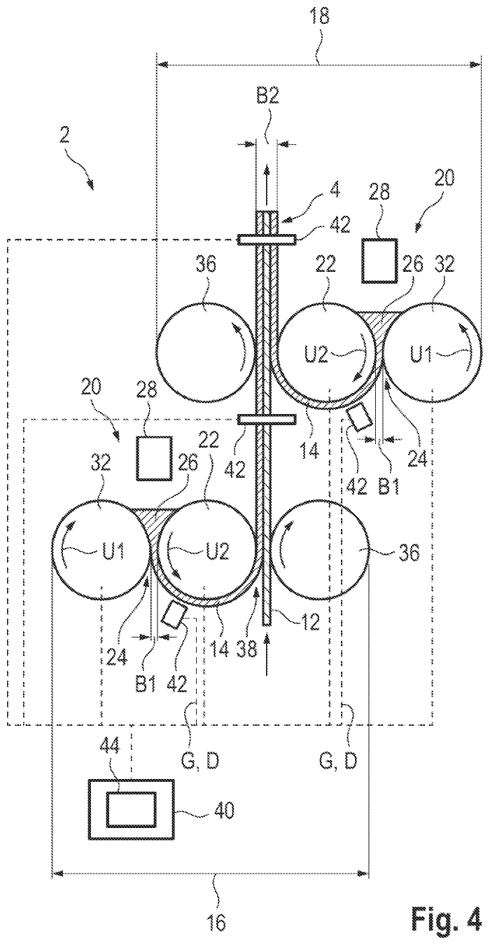

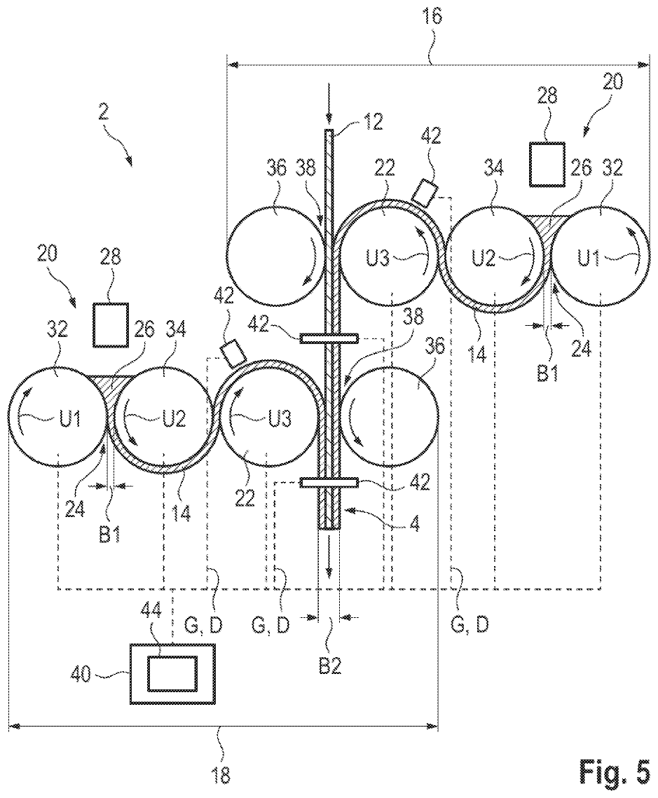

During the manufacturing of electrode sheet 4, a substrate 12 and at least one material film 14 are assembled. For the purpose of forming material film 14, rolling device 2 includes a rolling mill 16, 18 having a roller pair 20 and an application roller 22. Application roller 22 is either designed to be separate from roller pair 20 (cf. FIGS. 3 and 5) or is a part of roller pair 20 (cf. FIGS. 2 and 4). Rolling devices 2 shown here in FIGS. 2 through 5 each include multiple rolling mills 16, 18 for the purpose of coating substrate 12 with a material film 14 on both sides. In principle, however, embodiments including only one rolling mill 16, 18 are also possible.

Rolling mill 16, 18 has a film forming gap 24, which is formed by roller pair 20, i.e., film forming gap 24 is formed between the two rollers of roller pair 20 and thus has a gap width B1 which corresponds to the distance of the two rollers from each other. Film forming gap 24 outputs a quantity of material 26 (i.e., a quantity per time unit) and produces material film 14 therefrom. Gap width B1 greatly influences the production of material film 14. Material 26 for this purpose is supplied in the present case with the aid of a metering apparatus 28, namely to a gusset 30 which is formed between the two rollers of roller pair 20 and which opens into film forming gap 24.

Material 26 in the present case is present in the form of a powder and is free of liquid constituents or contains no more than a small amount of liquid constituents. A material of this type is also referred to as a “dry material” and is free of solvents.

The two rollers of roller pair 20 are operated at different circumferential speeds U1, U2 to produce material film 14. As a result, a shearing force arises at film forming gap 24, which acts upon material 26 and influences the production of material film 14 accordingly. The shearing force is dependent on a difference of the two circumferential speeds U1, U2, i.e., a relative speed of the two rollers of the roller pair 20 with respect to each other. The one of the two rollers which has the lower circumferential speed U1 is also referred to as shearing roller 32. The other of the two rollers is then either application roller 22 or is referred to as transfer roller 34. Material film 14 is produced on the roller which has the higher circumferential speed U2, i.e. on application roller 22 or transfer roller 34.

Within the scope of the method, material film 14 is applied to application roller 22. If application roller 22 is a part of roller pair 20, as illustrated in FIGS. 2 and 4, material film 14 is applied directly to application roller 22 starting from film forming gap 24. However, if application roller 22 is designed to be separate from roller pair 20, as illustrated in FIGS. 3 and 5, material film 14 is preferably applied directly to transfer roller 34 starting from film forming gap 24. Material film 14 is then transferred from film forming gap 24 to application roller 22 via transfer roller 34. Transfer roller 34 transfers material film 14 to application roller 22 either indirectly (not illustrated) or directly, as shown in FIGS. 3 and 5.

Substrate 12 in the present case is a foil made from a conductive material. Substrate 12 is supplied to application roller 22, and material film 14 is transferred from application roller 22 to substrate 12. Substrate 12 is optionally coated with an adhesion-promoting agent or the like to securely fix material film 14. The transfer of material film 14 to substrate 12 is also referred to as “lamination.”

As is apparent in FIGS. 2 through 5, material film 14 is not self-supporting but is continuously supported by one or multiple rollers from film forming gap 24 to substrate 12. Material film 14 is therefore also referred to as a “roller-supported material film.”

To transfer material film 14 to substrate 12, rolling device 2 includes a counter-roller 36 to application roller 22 in the illustrated exemplary embodiments. Counter-roller 36 is either a separate roller (cf. FIGS. 4 and 5) or an application roller 22 of a second rolling mill 18, similarly to (first) rolling mill 16 already described (cf. FIGS. 2 and 3). A gap 38 is then formed between counter-roller 36 and application roller 22, through which substrate 12 is passed and in which material film 14 is transferred to substrate 12. In the present case, material film 14 is not compressed or at most only slightly compressed during the transfer to substrate 12. In this case, gap 38 is also referred to as a “laminating gap.”

Material film 14 generally has a grammage G and a film thickness D. Film thickness D is measured perpendicularly to a width (perpendicularly to the image plane in FIGS. 2 through 5) and a length (in the image plane and along material film 14 in FIGS. 2 through 5, i.e., along a transport direction of material film 14) of material film 14 and its smallest extension. Grammage G indicates the mass per unit area of the material film, the unit area extending in the direction of the length and the width of material film 14.

Grammage G and also film thickness D are settable prior to transferring material film 14 to substrate 12 by means of a corresponding control of rolling device 2. In the present case, grammage G and/or film thickness D are regulated to a setpoint value, and rolling device 2 is controlled for this purpose depending on grammage G and/or film thickness D. This is understood to mean that either grammage G or film thickness D is regulated to a setpoint value or that both take place simultaneously, i.e., grammage G and film thickness D are regulated to a particular setpoint value. In the present case, an automatic setting and adaptation (namely a regulation) of rolling device 2 is implemented, whereby it is ensured that a predefined grammage G (“target loading”) and/or predefined film thickness (“target thickness”) are generated continuously or at least predominantly.

Electrode sheet 4 is therefore not processed only later on, i.e., after material film 14 is transferred to substrate 12, to set grammage G and film thickness D, but material film 14 is instead correspondingly suitably produced prior to the transfer to substrate 12.

To regulate grammage G and/or film thickness D to a particular setpoint value, rolling device 2 includes, in the exemplary embodiments illustrated here, a control unit 40 as well as at least one measuring unit 42 and at least one controller 44, which are connected to control unit 40 or are a part thereof. A control variable is measured with the aid of measuring unit 42, and an actual value is determined therefrom, which is then forwarded to one or multiple of controllers 44. Controller 44 is also supplied with the setpoint value. Depending on a deviation of the actual value from the setpoint value (control deviation), controller 44 then controls rolling device 2, i.e., a corresponding manipulated variable. Different suitable embodiments thereof are described below. These embodiments differ from each other, in particular, in the selection of the control variable and its measurement as well as in the manipulated variable, i.e., in how rolling device 2 is specifically controlled. The different embodiments or only individual aspects thereof may generally be combined with each other.

In particular, already mentioned gap width B1 of film formation gap 24 and relative speed Δ(U1, U2) of the rollers of roller pair 20 are suitable as the manipulated variable. Correspondingly, in one possible embodiment, rolling device 2 is controlled in that gap width B1 is set. Alternatively or additionally, rolling device 2 is controlled in that a difference of circumferential speeds U1, U2 is set. Due to the two measures, the quantity of material 26 which is output from film forming gap 24 (per time unit), is set directly in each case, and thus also grammage G and film thickness D of material film 14. If both gap width B1 and the relative speed are correspondingly controlled, grammage G and film thickness D may also be set independently of each other.

In one embodiment, grammage G or film thickness D or both are measured and used directly as the actual value. A corresponding target loading or target thickness is then used as the setpoint value. However, an embodiment is also possible, in which the actual value (and similarly the setpoint value) is only derived from grammage G or film thickness D or from both together and is correspondingly abstracted if possible. In a further embodiment, grammage G is derived from a measurement of film thickness D. For this purpose, film thickness D is measured, for example, on application roller 22 and then, in combination with circumferential speed U2 of application roller 22 and the quantity of material 26 output from film forming gap 24, an actual value for grammage G is calculated, and a regulation of grammage G is thus carried out, based on a measurement of film thickness D.

A measurement of grammage G and film thickness D at different points of rolling device 2 is possible, as is apparent in FIGS. 2 through 5. In the present case, grammage G and/or film thickness D is/are measured while material film 14 is being applied to application roller 22, or alternatively or additionally while material film 14 is being applied to substrate 12. Corresponding measuring units 42 are illustrated for this purpose in FIGS. 2 through 5, which measure either grammage G, film thickness D or both. The measurement of grammage G may take place, for example, on material film 14 on substrate 12, since it is regularly free-standing downstream from application roller 22, as is apparent in FIGS. 2 through 5. In principle, however, a measurement of grammage G on roller-supported material film 14 prior to the transfer to substrate 12 is also possible. In one embodiment, film thickness D is measured while material film 14 is being applied to application roller 22, and grammage G is measured while material film 14 is being applied to substrate 12. In one embodiment, in which a material film 14 is applied to each side of substrate 12, the measurement of grammage G supplies only one value (actual value) for both material films 14 together. With the aid of the additional measurement of film thickness D of individual material films 14 prior to the transfer to substrate 12, this value is then divided to the two material films 14 according to the ratio of the two film thicknesses D, and particular grammage G is thus determined at least approximately correctly for each of material films 14.

Similarly to gap width B1 of film forming gap 24 and the relative speed of the rollers of roller pair 20, in a rolling device 2 including a transfer roller 34, gap width B2 of gap 38 is alternatively or additionally used as the manipulated variable, on the one hand, and/or the relative speed between transfer roller 34 and application roller 22 is used as the manipulated variable, on the other hand. As already described, particular rolling device 2 in FIGS. 3 and 5 includes a transfer roller 34, which is arranged upstream from application roller 22 and via which material film 14 is transferred from film forming gap 24 to application roller 22. Rolling device 2 is then controlled in that a gap width B2 of gap 38 is set, and/or in that the difference of circumferential speeds U2, U3 (i.e., relative speed Δ(U2, U3)) of transfer roller 34 and application roller 22 is set.

Similarly to the measurement of grammage G and/or film thickness D on application roller 22, and alternatively or additionally hereto in one suitable embodiment, grammage G and/or film thickness D is/are likewise measured while material film 14 is being applied to transfer roller 34.

As is apparent in FIGS. 2 through 5, different configurations may be considered for rolling device 2, all of which are suitable for the method described here. The optional use of a transfer roller 34 has already been described. A coating on one or both sides of the substrate is also possible, only the latter being shown in FIGS. 2 through 5. Correspondingly, substrate 12 is coated on both sides with the aid of particular rolling device 2 in the present case. The already described (first) material film 14 is then applied to a first side of substrate 12, and rolling device 2 includes a further (second) rolling mill 18, with the aid of which a further (second) material film 14 is produced, which is applied to an opposite, second side of substrate 12. Second material film 14 also has a grammage G and a film thickness D. The production of the two material films 14 and their transfer to substrate 12 proceed in the same way, i.e., rolling device 2 has a rolling mill 16, 18 for each of material films 14. The measurements and regulating processes described are carried out equally according to the above and following descriptions for both rolling mills 16, 18 and material films 14. Rolling mills 16, 18 are either offset with respect to a transport direction of substrate 12 (cf. FIGS. 4 and 5), so that the two material films 14 are transferred to substrate 12 one after the other, or are arranged at the same position (cf. FIGS. 2 and 3), so that the two material films 14 are transferred to substrate 12 at the same time. In the latter case, the two application rollers 22 are then each also simultaneously a counter-roller 36 for the other application roller 22. In FIGS. 4 and 5, grammage G and/or film thickness D is/are also measured downstream from application roller 22 of first rolling mill 16 and upstream from application roller 22 of second rolling mill 18.

In the case of a substrate 12 coated on both sides, the two rolling mills 16, 18 are controlled in the present case in such a way that a difference of the two film thicknesses D is minimized, i.e., material films 14 are automatically designed to be of the same thickness.

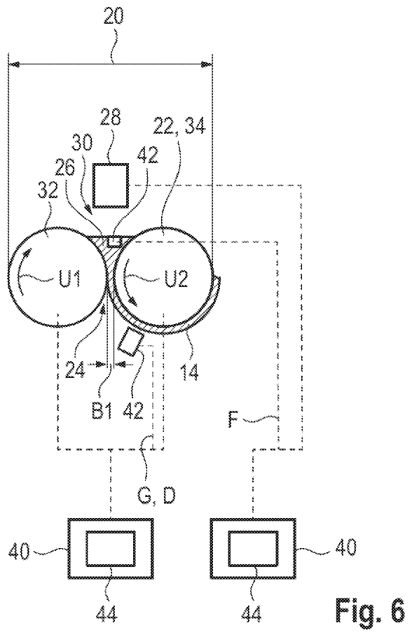

In one embodiment, a fill level of material 26 upstream from film forming gap 24 is optionally regulated to a fill level setpoint value, depending on a fill level actual value F or depending on grammage G and/or film thickness D, i.e., a fill level regulation takes place. This is illustrated, for example, in FIG. 6 and may be applied to the exemplary embodiments in FIGS. 2 through 5. This ensures that gusset 30 of roller pair 20 does not empty or overflow. The fill level regulation takes place either in a decentralized manner, and thus independently of the regulation of grammage G and/or film thickness D, in particular in that fill level actual value F is simply measured, and the supply of material 26 to gusset 30 is controlled depending thereon. Alternatively, the fill level regulation takes place centrally, in particular in that the supply is controlled depending on grammage G and/or film thickness D.

In addition, laminating gap 38 is optionally controlled, e.g., depending on grammage G and/or film thickness D.

Control unit 40 takes over one or multiple of the control and regulating tasks described above. All control and regulating tasks are either implemented centrally in a single control unit 40, as in FIGS. 2 through 5, or distributed in a decentralized manner to multiple corresponding control units 40, for example, a particular regulation is implemented for film thickness D and grammage G independently of each other using separate control units 40.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a rolling device for manufacturing an electrode sheet, the method comprising:
providing the rolling device with a rolling mill to form a material film for the electrode sheet, including a roller pair and including an application roller, which is designed to be separate from the roller pair or is a part of the roller pair;
supplying the application roller with a substrate for the electrode sheet;
forming a film forming gap, which is formed by the roller pair, which outputs a quantity of material, and which produces the material film therefrom;
applying the material film to the application roller;
transferring the material film from the application roller to the substrate;
providing the material film with a grammage and a film thickness, the grammage and/or the film thickness being regulated to a setpoint value;
controlling the rolling device based on the grammage and/or the film thickness.

2. The method according to claim 1, wherein the rolling device is controlled in that a gap width of the film forming gap is set.

3. The method according to claim 1, wherein the roller pair includes two rollers, which are operated at different circumferential speeds for producing the material film, the rolling device being controlled in that a difference of the circumferential speeds is set.

4. The method according to claim 1, wherein the grammage and/or the film thickness is/are measured on the material film while the material film is being applied to the application roller.

5. The method according to claim 1, wherein the grammage and/or the film thickness is/are measured on the material film while the material film is being applied to the substrate.

6. The method according to claim 1, wherein the rolling device includes a transfer roller, which is arranged upstream from the application roller and via which the material film is transferred from the film forming gap to the application roller, the rolling device being controlled in that a gap width of a gap between the transfer roller and the application roller is set and/or a difference of the circumferential speeds of the transfer roller and the application roller is set.

7. The method according to claim 1, wherein the rolling device includes a transfer roller, which is arranged upstream from the application roller and via which the material film is transferred from the film forming gap to the application roller, and wherein the grammage and/or the film thickness being measured on the material film while the material film is being applied to the transfer roller.

8. The method according to claim 1, wherein the material film is applied to a first side of the substrate, the rolling device including a further rolling mill with the aid of which a further material film is produced, which is applied to an opposite second side of the substrate and has a film thickness, the two rolling mills being controlled in such a way that a difference of the two film thicknesses is minimized.

9. The method according to claim 1, wherein the material is free of liquid constituents or contains no more than 3 wt. % of liquid constituents.

10. A rolling device comprising a control unit, wherein the control unit is designed to carry out the method according to claim 1.
